(19) United States
(12) Patent Application Publication
(10) Pub. No.: US 2012/0173744 A1
(43) Pub. Date: Jul. 5, 2012

(54) WIRELESS CONNECTION METHOD AND APPARATUS USING IMAGE RECOGNITION IN MOBILE COMMUNICATION TERMINAL

(76) Inventors: Kwang-Yong Lee, Seodaemun-gu (KR); Soon-Hwan Kwon, Seongnam-si (KR)

(21) Appl. No.: 13/395,419

(22) PCT Filed: Sep. 10, 2010
(86) PCT No.: PCT/KR2010/006176

§ 371 Date: Mar. 9, 2012

(30) Foreign Application Priority Data
Sep. 10, 2009 (KR) 1020090085245

(51) Int. Cl. H04W 76/02; G06F 15/16

(52) U.S. Cl. 709/228

(57) ABSTRACT

A method and apparatus for wireless connection with an external device using image recognition in a mobile communication terminal is provided. In the method for wireless connection with an external device using image recognition in a mobile communication terminal, an image including network connection information is acquired by a camera. The network connection information is acquired by recognizing the image through an image recognition algorithm. The wireless connection with the external device is performed using the acquired network connection information.

### TECHNICAL FIELD

The present invention relates to a wireless connection method and apparatus using image recognition in a mobile communication terminal. More particularly, the present invention relates to a method and apparatus for wireless connection with an external device by acquiring network information through image recognition. Background Art

As mobile communication terminals are widely spread due to their portability and convenience, mobile communication terminal providers are competitively developing terminals having more convenient functions to win over many users. Particularly, with recent progressive development of communication technologies, communication functions using wireless connection between wireless devices are being provided. For example, a function of providing voice signals to users by connecting a wireless headphone with a mobile communication terminal through Bluetooth communication technology is being provided. While the functions using wireless connection between wireless devices are being provided, technologies are being studied and developed to enable network setting for the wireless connection.

On the other hand, a wireless network environment has a limitation in that its security is lower than a wired network environment. That is, since data is moved along a predetermined wired path to be delivered to a predetermined device in a wired network while data is broadcast in an unspecific direction in a wireless network, there is a limitation in that the data may be delivered to devices other than the predetermined device. Accordingly, in a related art, data of a specific wireless device is prevented from being delivered to an undesired wireless device by performing security procedures between wireless devices to be wirelessly connected to each other.

However, the security and the network setting are in inverse proportion to each other. For example, if the security is enhanced, the quantity of information to be established for network connection and procedures to be performed for security increases. On the other hand, if the quantity of network connection information and the procedures are reduced for convenient network connection, its security is lowered.

Accordingly, it is necessary to provide techniques in which security is not lowered although network setting is simple and convenient for connection between wireless devices.

### DISCLOSURE OF INVENTION

### Solution to Problem

An aspect of the present invention is to substantially solve at least the above problems and/or disadvantages and to provide at least the advantages below. Accordingly, an aspect of the present invention is to provide a wireless connection method and apparatus using image recognition in a mobile communication terminal.

Another aspect of the present invention is to provide a method and apparatus for wireless connection with an external device by setting network information through image recognition.

Another aspect of the present invention is to provide a method and apparatus for wireless connection with an external device by acquiring network information of the external device through a camera in a mobile communication terminal.

In accordance with an aspect of the present invention, a method for wireless connection with an external device using image recognition in a mobile communication terminal is provided. The method includes acquiring an image including network connection information by a camera, acquiring the network connection information by recognizing the image through an image recognition algorithm, and performing the wireless connection with the external device using the acquired network connection information.

In accordance with another aspect of the present invention, a method for wireless connection with a mobile communication terminal in an external device is provided. The method includes displaying network connection information necessary for wireless connection with the mobile communication terminal on the outside, and performing the wireless connection with the mobile communication terminal using the network connection information.

In accordance with another aspect of the present invention, an apparatus for wireless connection with an external device using image recognition in a mobile communication terminal is provided. The apparatus includes a camera unit acquiring an image including network connection information, an image processing unit recognizing the image through an image recognition algorithm to acquire the network connection information, and a control unit controlling the wireless connection with the external device using the acquired network connection information.

In accordance with another aspect of the present invention, an apparatus for wireless connect with a mobile communication terminal in an external device In accordance with includes a display unit displaying network connection information necessary for the wireless connection with the mobile communication terminal, and a control unit controlling the wireless connection with mobile communication terminal using the network information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

The above and other aspects, features and advantages of the present invention will become more apparent from the following detailed description when taken in conjunction with the accompanying drawings in which:

FIG. 1 is a diagram illustrating a block configuration of a mobile communication terminal according to an embodiment of the present invention;

FIG. 2 is a diagram illustrating a block configuration of an external device according to an embodiment of the present invention;

FIG. 3 is a diagram illustrating a procedure of setting network information in a mobile communication terminal according to an embodiment of the present invention;

FIG. 4 is a diagram illustrating a network information generation procedure in an external device according to an embodiment of the present invention;

FIG. 5 is a diagram illustrating a screen configuration showing network information in an external device according to an embodiment of the present invention; and

FIG. 6 is a diagram illustrating a screen configuration for acquiring network information in a mobile communication terminal according to an embodiment of the present invention.

### BEST MODE FOR CARRYING OUT THE INVENTION

Preferred embodiments of the present invention will be described herein below with reference to the accompanying drawings. In the following description, detailed descriptions of well-known functions or constructions will be omitted since they would obscure the invention in unnecessary detail. Also, the terms used herein are defined according to the functions of the present invention. Thus, the terms may vary depending on user's or operator's intentions or practices. Therefore, the terms used herein must be understood based on the descriptions made herein.

Hereinafter, a method and apparatus for wireless connection with external devices by setting network information through image recognition in a mobile communication terminal. The external devices may include all devices capable of wireless communication with the mobile communication terminal. Examples of the external devices may include mobile communication terminals, game consoles, MP3s, TVs, and so forth.

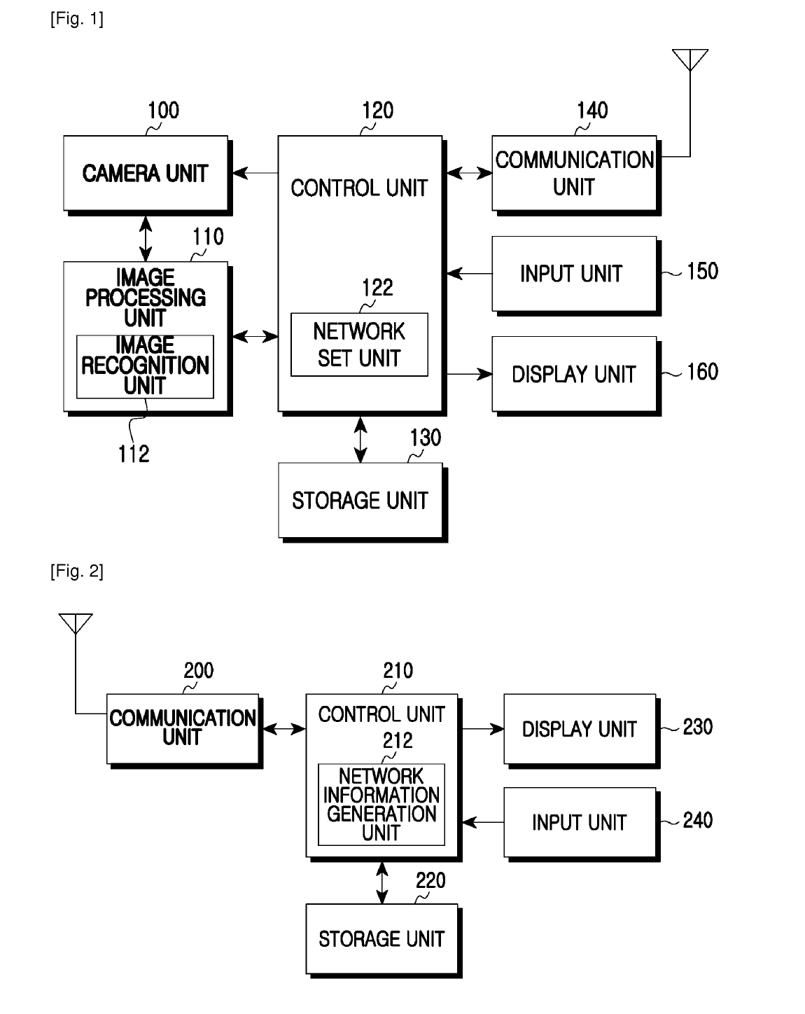

FIG. 1 is a diagram illustrating a block configuration of a mobile communication terminal according to an embodiment of the present invention. Here, the communication terminal may include a camera unit 100, an image processing unit 110, a control unit 120, a storage unit 130, a communication unit 140, an input unit 150, and a display unit 160. The image processing unit 110 may include an image recognition unit 112, and the control unit 120 may include a network setting unit 122.

Referring to FIG. 1, the camera unit 100 may include a camera sensor converting an optical signal sensed in photographing into an electrical signal, and a signal processing unit converting an analog image signal captured by the camera sensor into digital data. The camera unit 100 may output the digital data into the image processing unit 110. Particularly, the camera unit 100 may capture network information displayed on a screen of an external device, or attached to or inscribed on the external device to provide the captured network information to the image processing unit 110, according to the control of the control unit 120.

The image processing unit 110 may process the image signal outputted from the camera unit 100 by unit of frame to output it in accordance with the characteristics and size of the display unit 160. Also, the image processing unit 110 may include an image codec. The image codec may serve to code the image signal in a predetermined way, or may serve to decode coded frame image data to the original frame image data. Particularly, the image processing unit 110 may include the image recognition unit 112 to acquire network information from an image inputted from the camera unit 100 and provided it to the control unit 120 according to the control of the control unit 120. Here, the image recognition unit 112 may acquire network information from the image using widely-known image recognition algorithms.

The control unit 120 may control overall operations of the mobile communication terminal. The control unit 120 may include the network setting unit 122 to acquire network information of an external device through a camera upon occurrence of a wireless connection event with the external device and control and process a function for performing wireless network connection using the acquired information. That is, the control unit 120 may control the camera unit 100 to acquire an image including the network information of the external device, and may control the image processing unit 110 to recognize the network information from the acquired image, and then control and process a function for performing wireless connection with the external device by setting the recognized information to information for the network connection. Here, the network information, which is information necessary for wireless connection between the mobile communication terminal and the external device, may include an external device IDendifier (ID), a Service Set IDentifier (SSID), a Wired Equivalent Privacy (WEP) key, and a security key.

The storage unit 130 may store various kinds of programs and data necessary for overall operations of the mobile communication terminal.

The communication unit 140 may perform a function of transmitting/receiving a wireless signal of data inputted/outputted through an antenna. Particularly, the communication unit 140 may perform a procedure for wireless connection with an external device using wireless network information set according to the control of the control unit 120.

The input unit 150 may include a plurality of number keys and character keys, and function keys, and may provide data corresponding to a key pushed by a user to the control unit 120.

The display unit 160 may display status information and limited numbers and characters, which are generated during the operation of the mobile communication terminal. Particularly, the display unit 160 may display an image or image recognition result from the image processing unit 110 according to the control of the control unit 120.

FIG. 2 is a diagram illustrating a block configuration of an external device according to an embodiment of the present invention. Here, the external device may include a communication unit 200, a control unit 210, a storage unit 220, a display unit 230, and an input unit 240. The control unit 210 may include a network information generation unit 212.

Referring to FIG. 2, the communication unit 200 may perform a function of transmitting/receiving a wireless signal of data inputted/outputted through an antenna. Particularly, the communication unit 200 may perform a procedure for wireless connection with a mobile communication terminal.

The control unit 210 may control overall operations of the external device. The control unit 210 may include the network information generation unit 212 to generate network information necessary for wireless connection with the mobile communication terminal and control and process a function for displaying the network information upon occurrence of a wireless connection event with the mobile communication terminal. Here, the network information generation unit 212 may read out the network information recorded in the storage unit 220 to display it on the display unit 230, or may generate network information according to a predetermined manner to display it on the display unit 230. Also, the network information generation unit 212 may regenerate the network information according to a predetermined manner to control and process a function for displaying the regenerated network information when a network information change event occurs through the input unit 240.

The storage unit 220 may store various kinds of programs and data necessary for overall operations of the external device, and particularly, may store network information necessary for wireless connection with the mobile communication terminal.

The display unit 230 may display status information and limited numbers and characters, which are generated during the operation of the mobile communication terminal. Particularly, the display unit 230 may display network information according to the control of the control unit 210.

The input unit 240 may include number keys and character keys, and function keys, and may provide data corresponding to a key pushed by a user to the control unit 210. Particularly, the input unit 240 may receive a key for update of network information from a user to provide the key to the control unit 210.

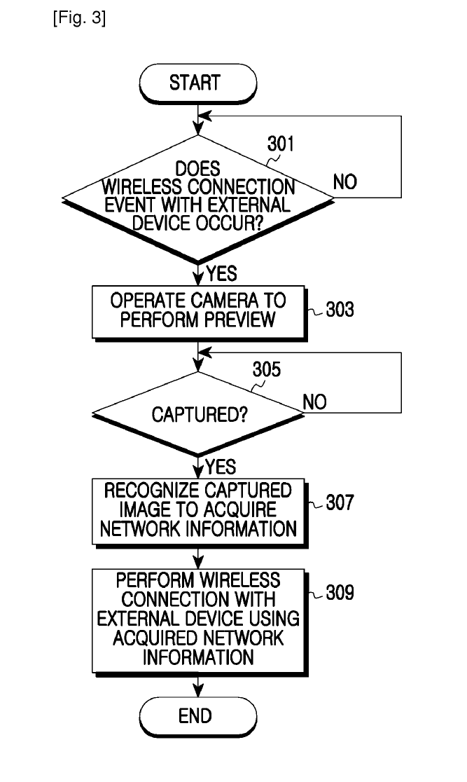

FIG. 3 is a diagram illustrating a procedure of setting network information in a mobile communication terminal according to an embodiment of the present invention.

Referring to FIG. 3, when a wireless connection event with an external device occurs in step 301, the mobile communication terminal may operate a camera to perform a preview in step 303. As illustrated in FIG. 6, this is for acquiring an image including network information necessary for wireless connection with the external device through a camera.

In step 305, the mobile communication terminal may check whether an image is captured by a user. When the image is captured, the mobile communication terminal may acquire network information by applying an image recognition algorithm to the captured image in step 307. For example, the mobile communication terminal may acquire an external device ID, a service set ID (SSID), a WEP key, and a security key.

In step 309, the mobile communication terminal may perform wireless connection with the external device, and close the algorithm according to the present invention.

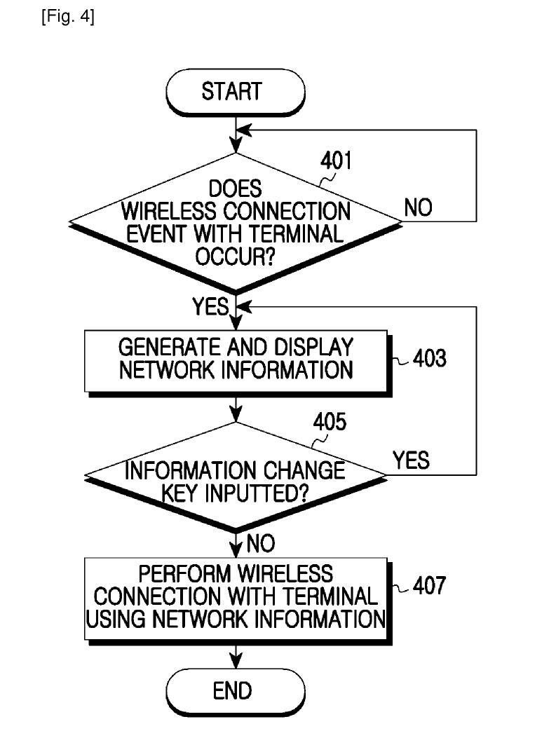

FIG. 4 is a diagram illustrating a network information generation procedure in an external device according to an embodiment of the present invention.

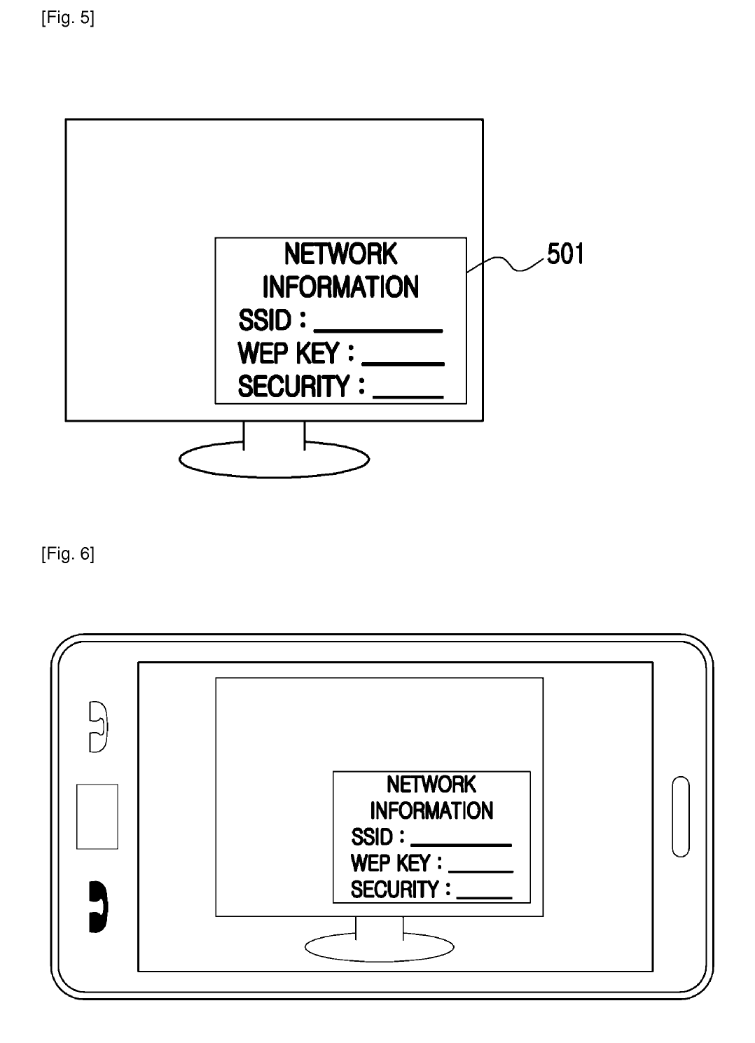

Referring to FIG. 4, in step 401, the external device may check whether an event for wireless connection with a mobile communication terminal occurs. When the event for wireless connection occurs, the external device may generate and display network information necessary for wireless connection with the terminal according to a predetermined manner in step 403. For example, the external device, as illustrated in FIG. 5, may generate and display network information 501 such as an external device ID, a server set ID (SSID), a WEP key, and a security key.

In step 405, the external device may check whether a key requesting for a network information change is inputted. When the key requesting for the network information change is inputted, the procedure returns to step 403, and the external device may generate and display the network information necessary for wireless connection with the mobile communication terminal. In this case, for security, the external device may generate and display network information having difference values from the previously generated network information.

On the other hand, when the key requesting for the network information change is not inputted, the external device may perform a procedure of wireless connection with the mobile communication terminal using the displayed network information, and close the algorithm according to the present invention.

In the present invention described above, the external device has displayed network information on its screen, but the network information may be attached to a certain region of the external device in a simply-printed form, or may be inscribed on the external device.

In a mobile communication terminal according to an embodiment of the present invention, wireless network connection with an external device may be easily performed only with photographing of a camera, by acquiring an image including network connection information from the external device through the camera, and then recognizing the network connection information from the acquired image. Also, the wireless network information may be newly generated, and its security may be enhanced only with a simple key input in an external device.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. A method for wireless connection with an external device using image recognition in a mobile communication terminal, the method comprising:
acquiring an image comprising network connection information by a camera;
acquiring the network connection information by recognizing the image through an image recognition algorithm; and
performing the wireless connection with the external device using the acquired network connection information.

2. The method of claim 1, wherein the network connection information comprises at least one of an external device identifier, a Service Set IDentifier (SSID), a Wired Equivalent Privacy (WEP) key, and a security key.

3. A method for wireless connection with a mobile communication terminal in an external device, the method comprising:
displaying network connection information necessary for wireless connection with the mobile communication terminal on an outside of the external device; and
performing the wireless connection with the mobile communication terminal using the network connection information.

4. The method of claim 3, wherein the network connection information comprises at least one of an external identifier, a Service Set IDentifier (SSID), a Wired Equivalent Privacy (WEP) key, and a security key.

5. The method of claim 3, wherein the network connection information is displayed on a screen of the external device.

6. The method of claim 3, wherein the network connection information is inscribed on or attached to a certain region of the external device.

7. The method of claim 3 further comprising:
changing the network connection information according to a key input by a user to display the changed network connection information.

8. An apparatus for wireless connection with an external device using image recognition in a mobile communication terminal, the apparatus comprising:
a camera unit configured to acquire an image comprising network connection information;
an image processing unit configured to recognize the image through an image recognition algorithm to acquire the network connection information; and
a control unit configured to control the wireless connection with the external device using the acquired network connection information.

9. The apparatus of claim 8, wherein the network connection information comprises at least one of an external identifier, a Service Set IDentifier (SSID), a Wired Equivalent Privacy (WEP) key, and a security key.

10. An apparatus for wireless connection with a mobile communication terminal in an external device, the apparatus comprising:
a display unit configured to display network connection information necessary for the wireless connection with the mobile communication terminal; and
a control unit configured to control the wireless connection with mobile communication terminal using the network information.

11. The apparatus of claim 10, wherein the network connection information comprises at least one of an external identifier, a Service Set IDentifier (SSID), a Wired Equivalent Privacy (WEP) key, and a security key

12. The apparatus of claim 10, wherein the network connection information is displayed on a screen of the external device.

13. The apparatus of claim 10, wherein the network connection information is inscribed on or attached to a certain region of the external device.

14. The apparatus of claim 10, wherein the control unit is further configured to change the network connection information according to a key input by a user to provide the changed network connection information to the display unit.

15. The method of claim 1, wherein the network connection information is recognized from the image of a screen of the external device.

16. The method of claim 1, wherein the network connection information is recognized from the image of an inscription on or attachment to a certain region of the external device.

17. The method of claim 1 further comprising:
requesting to change the network connection information according to a key input by a user.

18. The apparatus of claim 8, wherein the image processing unit is further configured to recognize the network connection information from the image of a screen of the external device.

19. The apparatus of claim 8, wherein the image processing unit is further configured to recognize the network connection information from the image of one of an inscription on and attachment to a certain region of the external device.

20. The apparatus of claim 8, wherein the control unit is further configured to control to request to change the network connection information according to a key input by a user.
